(19) United States
(12) Patent Application Publication
(10) Pub. No.: US 2005/0153821 A1
(43) Pub. Date: Jul. 14, 2005

(54) Method of making a metal outer surface about a composite or polymer cylindrical core

(76) Inventor: Grigoriy Grinberg, Sylvania, OH (US)

Correspondence Address: Grigoriy Grinberg, 4758 Mount Airy Road, Sylvania, OH, 43560, US

(21) Appl. No.: 10/886,103

(22) Filed: Jul. 7, 2004

Related U.S. Application Data
(60) Provisional application No. 60/535,236, filed on Jan. 9, 2004.

(51) Int. Cl. B25F 5/02; F16C 13/00

(52) U.S. Cl. 492/44; 29/895.32; 29/895.21; 29/895.211; 492/50

(57) ABSTRACT

The present invention relates to a novel method of manufacturing a metal surface, for the purpose of creating a substrate suitable for coating, about a cylindrical core such as a fluid metering roll or fluid metering sleeve, comprised of carbon fiber composite, glass fiber composite, Kevlar fiber composite, other composite, foam, rubber, polymer, plastic, or any combination thereof. More particularly, it relates to a method for wrapping the cylindrical core with wire composed of aluminum, nickel, steel, stainless steel, or other metals or alloys thereof that may be formed into a wire of round, square, rectangular, or otherwise polygonal profile, and applying coatings of metal, ceramic or carbide or combinations thereof.

### CROSS REFERENCE TO RELATED APPLICATIONS

This application claims the benefit of U.S. Provisional Application No. 60/535,236 by Grigoriy Grinberg, filed Jan. 9, 2004.

### BACKGROUND OF THE INVENTION

1. Field of Invention

The present invention relates to a novel method of manufacturing a metal surface about a composite or polymer industrial roll or industrial sleeve for the purpose of creating a substrate suitable for thermal spray coating. More particularly the invention relates to a method of manufacturing a metal surface about a cylindrical core such as a fluid metering roll or fluid metering sleeve, comprised of polyester fiber composite, carbon fiber composite, glass fiber composite, kevlar fiber composite, other composite, foam, rubber, polymer, plastic, or any combination thereof.

2. Description of Prior Art

The present invention is primarily directed to fluid-metering rolls or fluid-metering sleeves, such as anilox rolls or anilox sleeves, having a cylindrical core with a ceramic outer surface and laser-engraved with a multiplicity of cells in a predetermined pattern.

There are several existing and excepted methods, described hereinafter, of creating the fluid metering surface about a core and are comprised of, but not limited to:
(a) a metal roll mechanically engraved with a multiplicity of cells in a predetermined pattern;
(b) a metal roll coated with ceramic, and laser-engraved with a multiplicity of cells in a predetermined pattern;
(c) a composite core with a pressed on aluminum tube producing a metal outer surface, as described in U.S. Pat. No. 5,797,322 to Lorig et al. (1998), and further coated with ceramic on the outer surface, and further laser-engraved with a multiplicity of cells in a predetermined pattern.

(d) a composite core coated with metal utilizing a thermal spray process to produce a metal outer surface, and further coated with ceramic on the outer surface, and further laser-engraved with a multiplicity of cells in a predetermined pattern as described in U.S. Pat. No. 5,857,950 to Hycner (1999).

The existing methods of producing a fluid metering roll or fluid metering sleeve are generally categorized as composite core rolls, composite core sleeves or metal rolls. The high weight and inertia of the metal roll in methods (a) and (b) makes them undesirable because changing rolls and performing maintenance requires special lifting and handling equipment. The metal rolls are heavy and not well suited for operation in gearless printing equipment due to the high inertia when accelerating and de-accelerating. The cost of these rolls is typically high and compels the user to rework the roll rather than disposing of the roll if the outer surface wears or is damaged. The light weight composite core rolls and sleeves used in the methods (c) and (d) can be maintained or changed by hand, making them superior to metal rolls in methods (a) and (b). The light weight composite core rolls and sleeves are easy to handle and are well suited for operation in gearless printing equipment.

A composite or polymer cylindrical core with a surface suitable for thermal spray ceramic is key in fluid metering applications because direct application of thermal spray ceramic on a composite or polymer cylindrical core would damage the core surface due to the high temperature of the spray. Furthermore, ceramic does not bond to the polymer-based outer surface of the composite or polymer core. Two methods (c) and (d) are utilized to isolate the core during the application of thermal spray ceramic to prevent the molten spray from melting the composite or polymer core.

The method in (c) of incorporating an aluminum tube in the core design is costly and adds significant weight. The main source of the cost is the precise and time-consuming machining required to manufacture the tube. The aluminum tube method requires a wall thickness of typically 0.200 inch to maintain structural rigidity during manufacturing. This wall thickness requirement adds considerable weight to the composite core. Furthermore the size of the cylindrical core is limited by this method. Manufacturing a larger diameter tube over 10″ is more expensive due to the fact that extrusion equipment necessary to produce large diameter tubing is not readily available. The ability to manufacture a roll with a larger diameter signifies a competitive advantage since wider rolls require larger diameters to maintain structural rigidity. As a result, there is a tendency in the flexographic printing industry toward larger diameter rolls. The method in (c) prevents the use of a composite roll or a composite sleeve for large roll applications, thereby necessitating the use of a metal roll.

In method (d) a metal intermediate layer is thermal sprayed onto the core surface at a low temperature to produce a surface suitable for applying thermal spray ceramic. The disadvantages to the method in (d) are the cost and the low bond strength between the spray metal intermediate layer and the outer surface of the composite core. The cost of spraying a thick metal layer, typically at least 0.040 inch thick, to isolate the core is expensive and time-consuming. The deposition efficiency of the thermal spray process in method (d) is typically between 40 and 60 percent. The spray material and spray facility time becomes costly when spraying a thick layer at the described deposition efficiency. Spraying large composite cores over 8 inches in diameter with this method is not cost competitive. Additionally, spraying a thick intermediate layer will result in a rough outer surface that will require grinding. Also, the spray intermediate layer is limited to low melting point alloys such as zinc. Depending on the composite core material, a Coefficient of Thermal Expansion (CTE) mismatch between the core and the zinc alloy may bring about cracking.

Considering the shortcomings of the present technology, it would be desirable to create a new method of making a metallic layer between the cylindrical core and the ceramic at reduced cost and production time while not limiting the size or material of the roll or sleeve.

A search of prior art found the following patents, relevant to the present invention:

| | |
|---|---|
| U.S. Pat. No. 4,009,658 | Heurich |
| U.S. Pat. No. 4,819,558 | Counard |
| U.S. Pat. No. 5,221,562 | Morgan |
| U.S. Pat. No. 5,409,732 | Leonard, et. al. |
| U.S. Pat. No. 5,476,685 | Rocher, et. al. |
| U.S. Pat. No. 5,797,322 | Lorig, et. al. |
| U.S. Pat. No. 5,857,950 | Hycner |
| U.S. Pat. No. 5,967,959 | Niemi, et. al. |
| U.S. Pat. No. 6,240,639 | Hycner |
| U.S. Pat. No. 6,290,834 | Pearsall |
| U.S. Pat. No. 6,401,613 | Gayle, et. al. |
| U.S. Pat. No. 6,604,462 | Achelpohl |

### BRIEF SUMMARY OF THE INVENTION

The present invention relates to a method of manufacturing a metal surface about a cylindrical core, such that the core is wrapped with wire, and subsequently coated with ceramic or carbide or metal or a combination thereof comprising:

(a) preparing the outer diameter of the core by roughening, such as grit blasting, sanding, and degreasing with acetone, MEK, or other compatible solvent, or any combination thereof; and

(b) applying adhesive to the prepared outer surface of the core, such as epoxy, polyurethane, or any other adhesive which promotes bonding of metal wire to the cylindrical core; and

(c) wrapping the cylindrical core with wire, being comprised of aluminum, nickel, steel, stainless steel, copper, zinc or other metals or alloys thereof that may be formed into a wire of round, square, rectangular, or otherwise polygonal profile, such that each turn of wire lies in continuous contact with the previous turn, and further immobilizing the ends of the wire; and

(d) applying ceramic or carbide or metal or a combination of layers thereof over the wire; and

(e) grinding the outer surface to the required diameter and surface finish; and

(f) laser-engraving the ceramic or carbide outer surface if the intended application is that of a fluid metering roll.

Several intermediate steps may be performed as part of the present invention which depends on the process flow described hereinafter. Several examples of possible process flows that may be executed in the implementation of the invention are prescribed herein. These flow paths are illustrated in FIG. 1. The possible methods diverge following the wire winding step and will be described thereafter.

As described, the wire may be any metal such as aluminum, nickel, steel, stainless steel, copper, zinc or other metal or alloy that can be manufactured into a wire of round, square, rectangular, or otherwise polygonal profile. The term polygonal profile for the present invention is a closed plane figure bounded with straight or curved or a combination of curved and straight sides. An example of a wire with a polygonal profile is shown in FIG. 15 and FIG. 16. Furthermore the wire can be formed or surfaced with flatteners or knurling devices. As shown in FIG. 14A a round wire is further processed in a flattener to produce a flattened wire as in FIG. 14B. A cylindrical core wrapped with a flattened wire is shown in FIG. 8. The wire surface can be altered with a knurling or similar device to roughen the surface to improve bonding. A combination of wires with identical or different profiles and produced from identical or different materials may be combined to form a wire article, such as a cable as shown in FIG. 13. In FIG. 12, the cylindrical core is wrapped with two layers of wire. Several examples of cylindrical cores (10) with adhesive (5) and wrapped with various wire profiles are shown in FIG. 7 through FIG. 11. In some applications, hollow wire can be utilized to save weight or to improve flexibility of the wire.

The term “Wire” for the present invention may be interpreted to mean a single wire or a multiple-strand wire, composed of one material or a combination of materials. This clarification is required since using a multiple-strand wire, referred to as a cable, would be advantageous in certain situations. There are two possible advantages to using cable; a cable has greater surface area and thus provides a coating bond better than wire of similar diameter; and cable is more flexible than wire of similar diameter.

The wire wrapping step is the distinctive aspect of this invention, however immobilizing the wire at the beginning and end of the core is critical. The wire may be fixed to the cylindrical core, to an adjacent wrap of wire or to any other component attached or mounted to the cylindrical core. Several wire immobilization techniques are possible based on the cylindrical core design. In FIG. 2A the wire is attached to the cylindrical core by a hole (16) drilled in the core. FIGS. 5A and 5B illustrate another immobilization technique by cutting or machining a groove (9) in the composite core surface and bonding the wire (6) in the groove with adhesive (5). In the case that the cylindrical core will be manufactured into a roll, the wire can be immobilized in the end cap as in FIG. 18A and FIG. 18B. Depending on the application, immobilization of the wire can be mechanical, chemical, metallurgical or a combination thereof by utilizing holes, grooves, adhesives, welding, soldering, brazing, clamping or screwing. Immobilization of wire, filaments, fiber and other articles are known to those skilled in winding and spooling products such as rolls, cylindrical cores, sleeves, shafts or mandrels.

In another embodiment, a metal buildup layer (8) as in FIG. 4A and FIG. 4B may be prescribed prior to the application of ceramic or other coating in order to create a surface radially equidistant from the longitudinal axis of the core. After the application of metal build up layer, the outer surface may be grinded, machined or mechanically roughened or a combination thereof to prepare the surface for application of ceramic or other coating. The cylindrical core may be utilized in some applications with only the buildup layer.

It would be preferable in certain situations, such as fluid-metering rolls, to apply coats of sealer after certain layers as in FIG. 1, and particularly after the layer of ceramic. The sealer may be selected from the group comprising, but not limited to, epoxy-based and polyurethane-based.

Depending on the application, a cylindrical core can be manufactured to function in various forms, such as a sleeve or a roll. FIG. 17 depicts a method of producing a roll from a composite cylindrical core by adding journal end plugs (15) to the core. FIG. 19A and FIG. 19B shows another type of roll assembly utilizing a composite cylindrical core, referred to as a sleeve. Sleeves are mounted on a cylinder, commonly referred to as a mandrel. Several mandrel designs exist for sleeves depending on the application. In FIG. 19A and FIG. 19B the sleeve is mounted to the mandrel (19) utilizing a compressed air to deflect or compress the sleeves compressible layer (2) as in FIG. 19A. This mandrel design is commonly referred to as an air assisted mandrel. Other designs use tapered mandrels with tapered sleeves or sleeves on mandrels with mechanical attachments.

In another embodiment, an end cap may be utilized. FIG. 20 illustrates an attached end cap design for a sleeve with a compressible core. More preferably an end cap as shown in FIG. 21 with a radial groove in the end cap and an aligned radial groove in the composite core filled with adhesive (22) is utilized to produce a locking element to attach the end cap to the composite core. Other designs to lock and attached the end cap using spring clips and other mechanical devices are possible. Many other designs of journal plugs, end caps and mandrels are utilized by those skilled in the art of producing rolls, sleeves, shafts, cylindrical cores and mandrels.

The present invention described herein would be effective and economical in industrial roll or industrial sleeve applications, such as textile, paper, steel, plastic, or printing, wherein the application of a wear-resistant, chemical-resistant or metal outer surface material is required on a polymer or composite cylindrical surface.

The process described is superior to the other methods of producing a surface suitable for thermal spray coating. The method described herein is inexpensive and requires minimal time. The present invention is unique compared to other methods in that this method is not limited by the size or material of the composite or polymer core. Furthermore, the wire size and wire material can be tailored to the applications environment.

### BRIEF DESCRIPTION OF THE DRAWINGS

The invention will be described in relation to the following illustrations. In FIGS. 2 through 21, the key is as follows:
(1) fiber composite layer
(2) compressible layer
(3) fiber composite layer
(4) polymer layer
(5) adhesive
(6) wire layer
(7) coating layer
(8) metal buildup layer
(9) wire attachment groove
(10) composite or polymer core
(11) wire with flattened profile
(12) wire with square profile
(13) wire with Z-shaped interlocking polygonal profile (straight sides)
(14) wire with Z-shaped interlocking polygonal profile (curved sides)
(15) journal end plug
(16) wire attachment hole
(17) thermal spray device
(18) cooling gas
(19) mandrel
(20) end cap with locking groove
(21) end cap
(22) adhesive
(23) end cap wire attachment hole

FIG. 1 is a process flow diagram which comprises possible variations of the present invention.

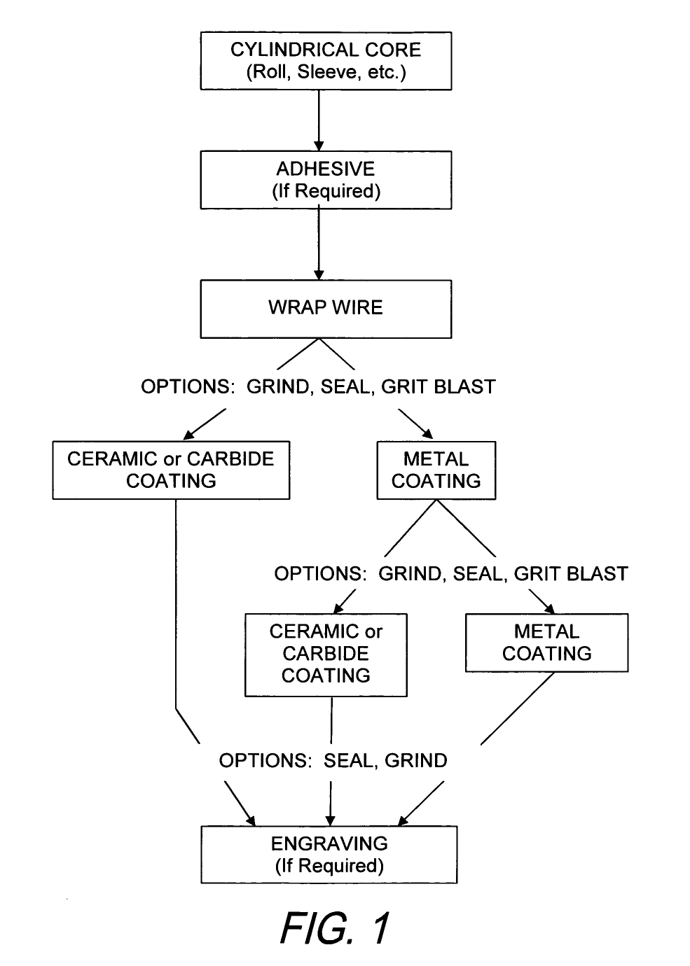

FIG. 2A and FIG. 2B depicts a cross-sectional end view of a composite cylindrical core produced from a fiber composite layer (1), compressible layer (2), fiber composite layer (3) and polymer layer (4). FIG. 2A illustrates the attachment hole (16) before inserting wire. FIG. 2B illustrates the wire inserted in the attachment hole and the wire (6) wrapped on the cylindrical core surface.

FIG. 3A and FIG. 3B depicts a composite cylindrical core produced from a fiber composite layer (1), compressible layer (2), fiber composite layer (3) and polymer layer (4) with a layer of adhesive (5), wire (6) and coating (7). FIG. 3A illustrates a longitudinal cross section view and FIG. 3B illustrates a cross-section end view.

FIG. 4A and FIG. 4B depicts a composite cylindrical core produced from a fiber composite layer (1), a compressible layer (2), a fiber composite layer (3) and a polymer layer (4) with a layer of adhesive (5), wire (6) buildup layer of metal (8) and a coating (7). FIG. 4A illustrates a longitudinal cross section view and FIG. 4B illustrates a cross-section end view.

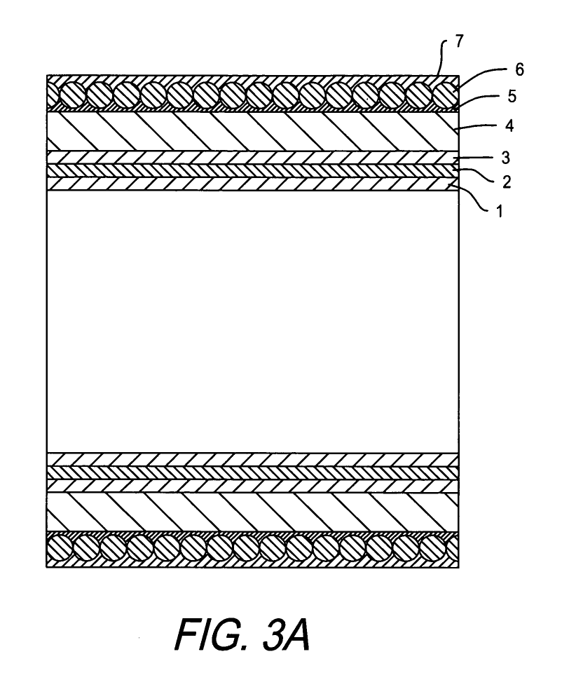

FIG. 5A and FIG. 5B depicts a wire attachment method for a composite cylindrical core produced from a fiber composite layer (1), a compressible layer (2), a fiber composite layer (3) and a polymer layer (4) with a layer of adhesive (5) and wire (6). FIG. 5A illustrates a longitudinal cross-sectional view of the cylindrical core with attachment groove (9) cut or machined into polymer layer (4). FIG. 5B illustrates a cross-sectional end view I-I of the cylindrical core with wire inserted in the attachment groove (9).

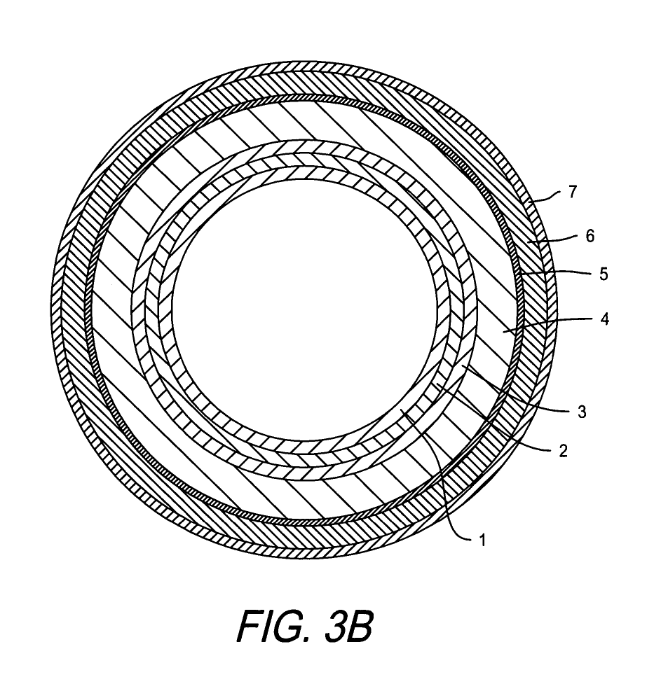

FIG. 6 depicts the orientation of the thermal spray device (17) and cooling gas (18) during application of thermal spray coating (7) on a rotating composite cylindrical core produced from a fiber composite layer (1), a compressible layer (2), a fiber composite layer (3) and a polymer layer (4) with a layer of adhesive (5) and wire (6).

FIG. 7 depicts a longitudinal cross-section view of a cylindrical core (10) with adhesive (5) and wrapped with round wire (6).

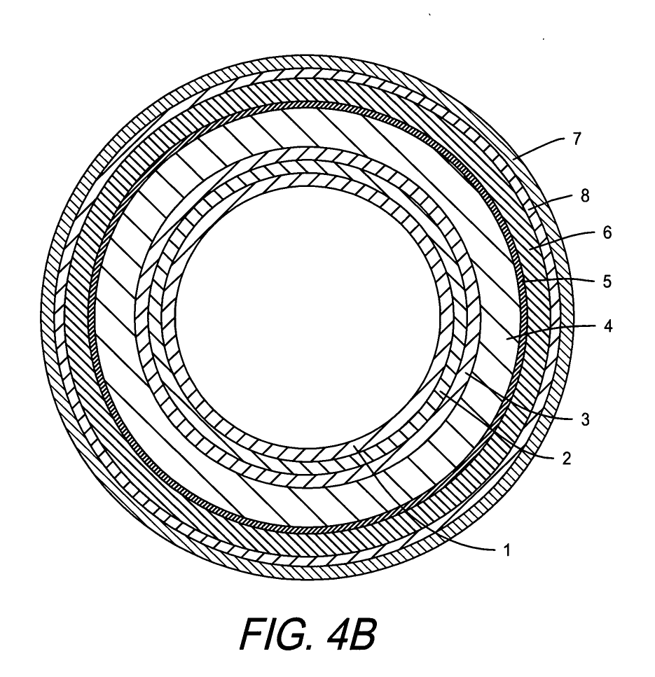

FIG. 8 depicts a longitudinal cross-section view of a cylindrical core (10) with adhesive (5) and wrapped with a flattened wire (11).

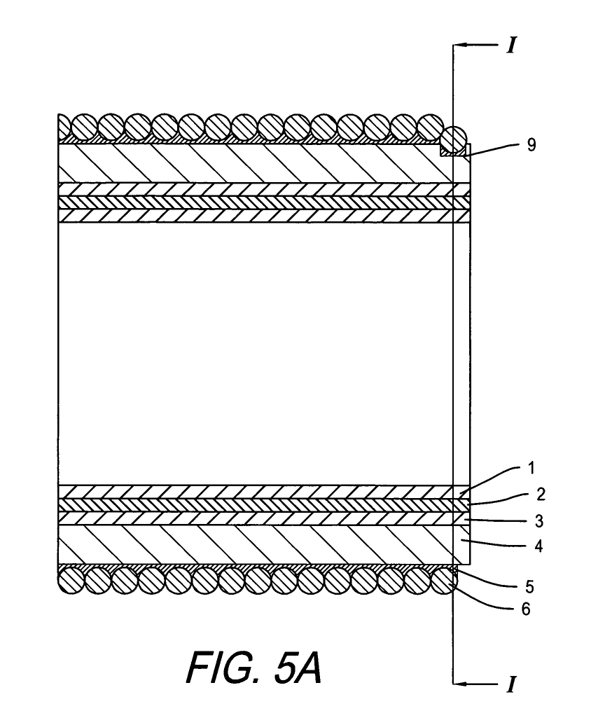

FIG. 9 depicts a longitudinal cross-section view of a cylindrical core (10) with adhesive (5) and wrapped with a square profile wire (12).

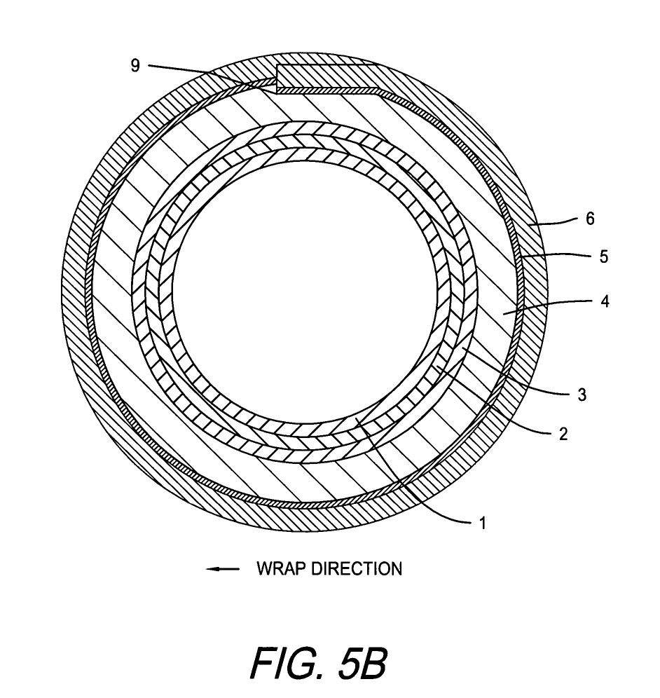

FIG. 10 depicts a longitudinal cross-section view of a cylindrical core (10) with adhesive (5) and wrapped with a straight sided Z-shaped interlocking polygonal profile wire (13).

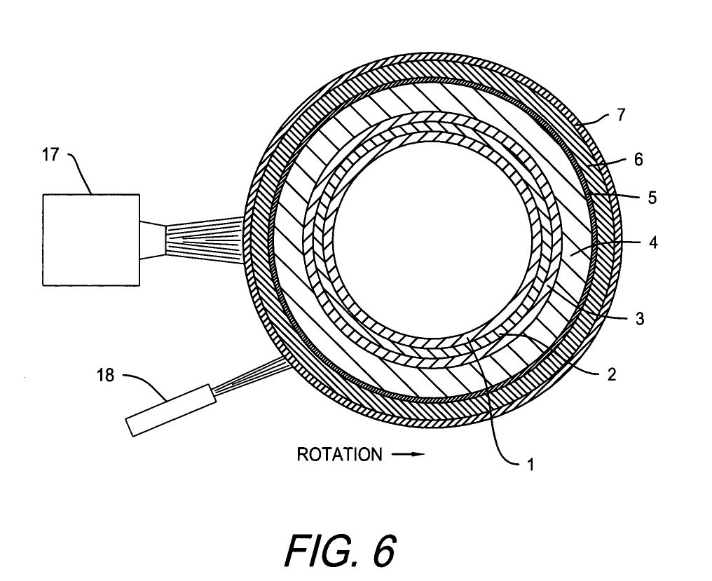

FIG. 11 depicts a longitudinal cross-section view of a cylindrical core (10) with adhesive (5) and wrapped with a Z-shaped interlocking polygonal profile wire (14) with a combination of straight and curved sides.

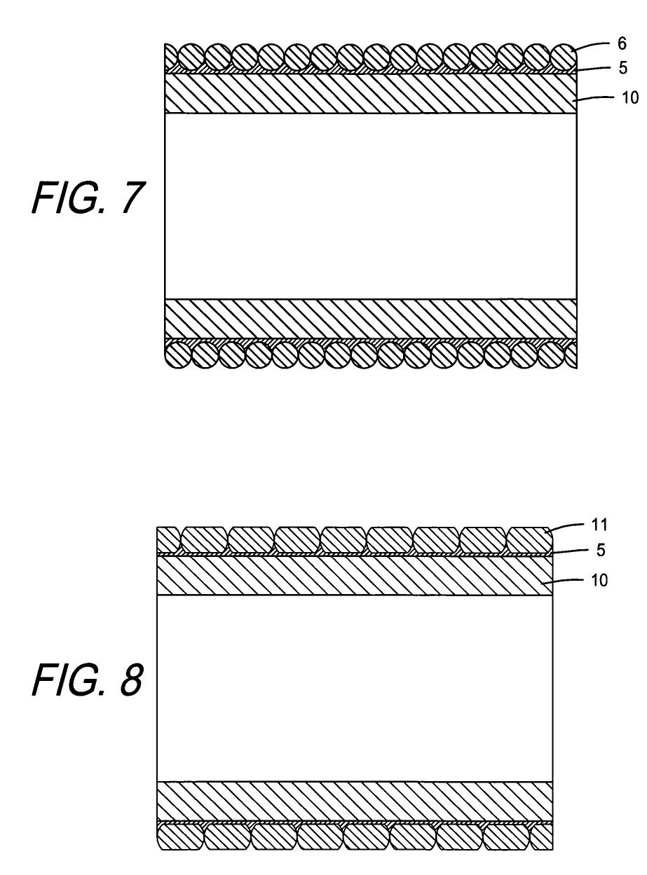

FIG. 12 depicts a longitudinal cross-section view of a fiber composite layer (1), compressible layer (2), fiber composite layer (3) and polymer layer (4) with a layer of adhesive (5), two layers of wire (6) and a coating (7).

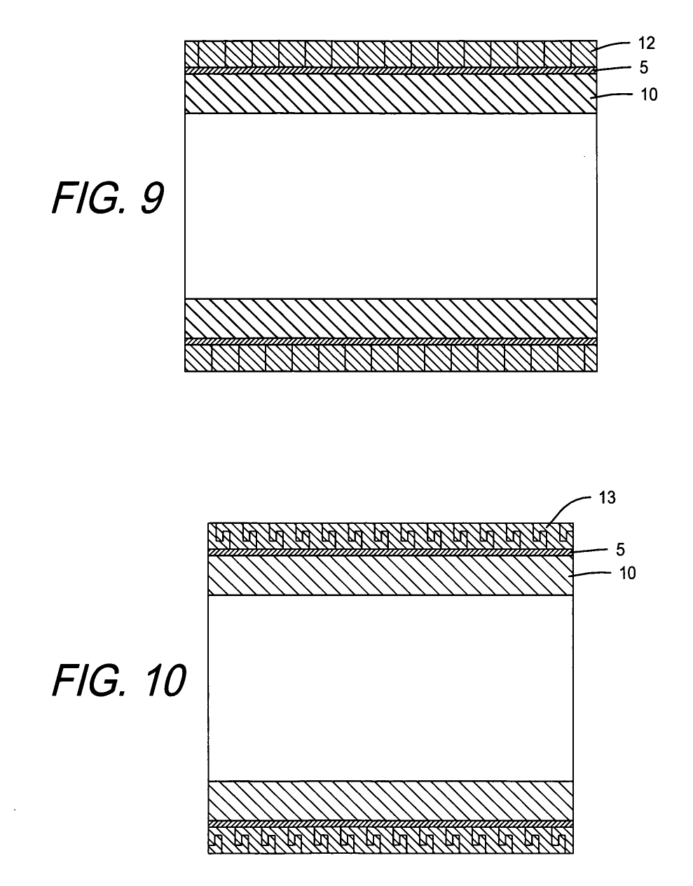

FIG. 13 depicts a cross-section of a multi-stranded wire producing a cable.

FIG. 14A depicts a cross-section of a round wire before formed in a flattener to produce a polygonal profile depicted in FIG. 14B.

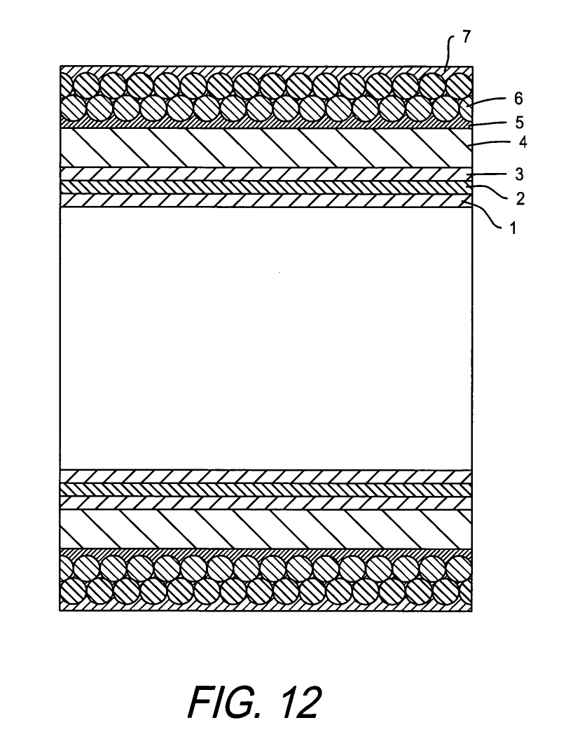

FIG. 15 depicts a cross-section of a Z-shaped interlocking polygonal profile wire with straight sides.

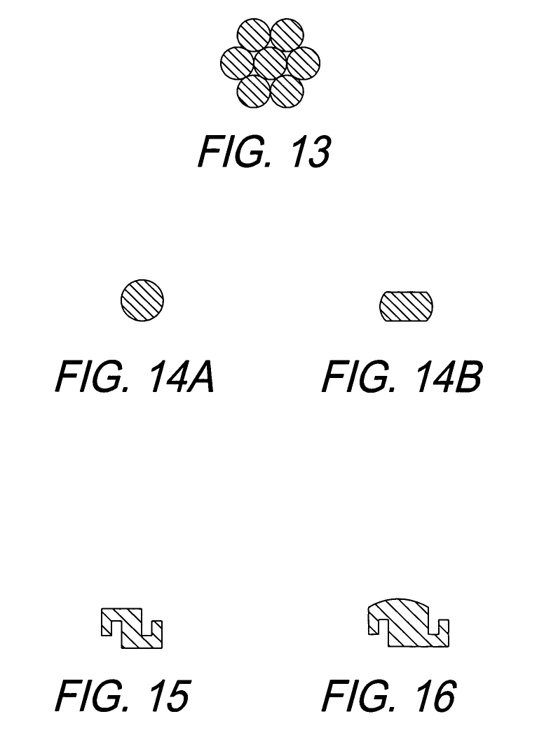

FIG. 16 depicts a cross-section of a Z-shaped interlocking polygonal profile wire with a combination of curved and straight sides.

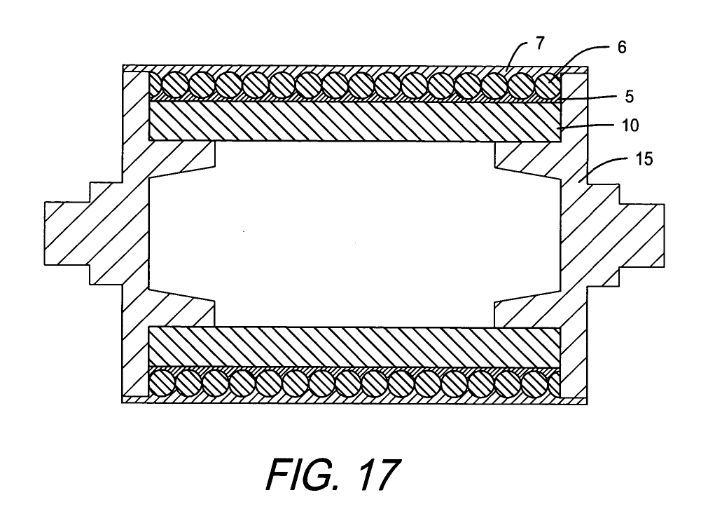

FIG. 17 depicts a longitudinal cross-section view of a cylindrical core (10) with adhesive (5), wire (6) and attached journal end plugs (15) to produce a roll with a coating layer (7).

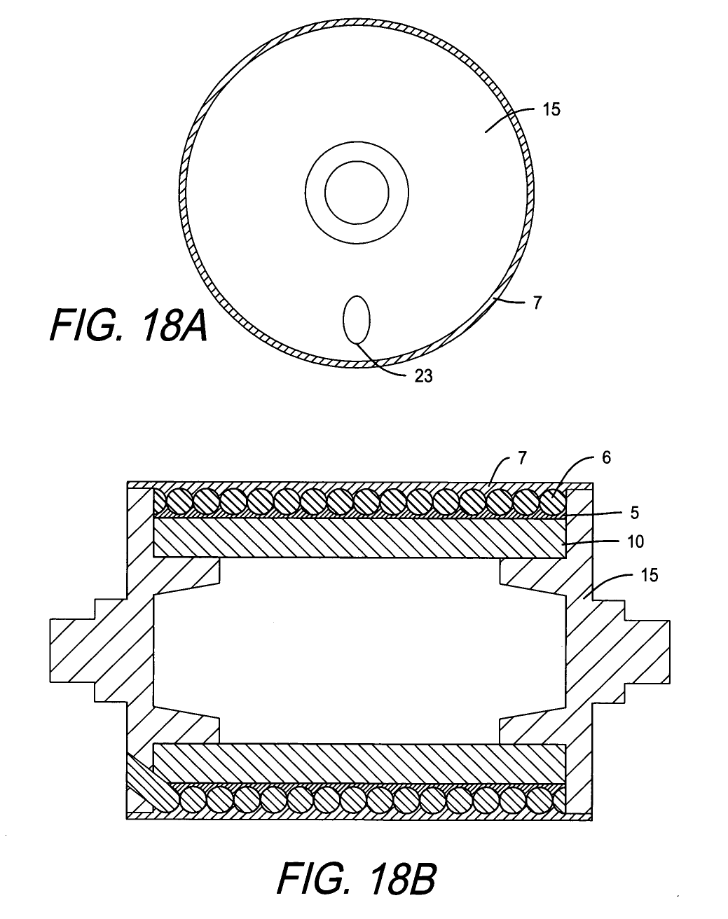

FIGS. 18A and 18B depicts a wire attachment method for a cylindrical core with journal end plugs. FIG. 18A illustrates an end view of the roll with journal end plug (15) and wire attachment hole (23). FIG. 18B illustrates a longitudinal cross-section view of a cylindrical core (10) with adhesive (5), wire (6) and attached journal end plugs (15) to produce a roll and with a coating layer (7). FIG. 18B is sectioned through the attachment hole.

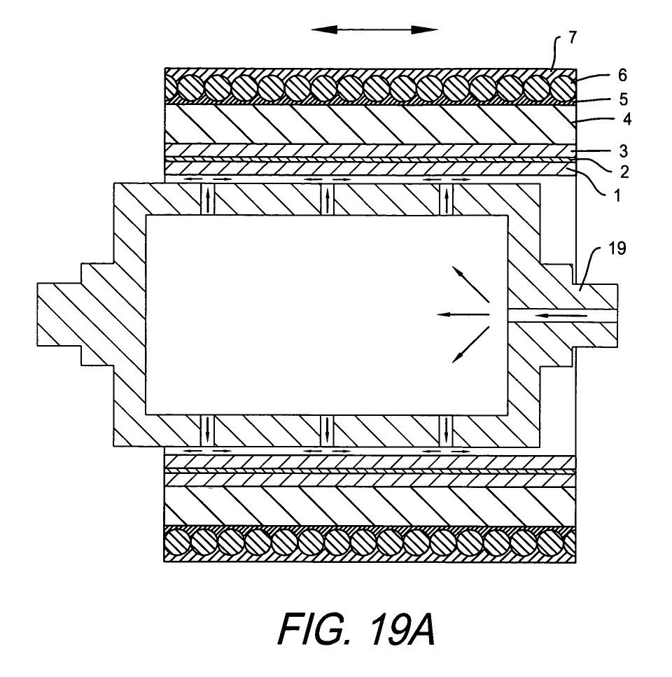

FIGS. 19A and 19B depicts a longitudinal cross-section view of a composite cylindrical core, referred to as a sleeve, produced from a fiber composite layer (1), a compressible layer (2), a fiber composite layer (3) and a polymer layer (4) with a layer of adhesive (5), wire (6) and coating (7) during installation on an air assisted mandrel (19). During sleeve installation, compressed air is supplied to the mandrel (19) and exits on points on the mandrel surface as in FIG. 19A, thereby compressing the compressible layer (2) and providing a layer of air to easily slide the sleeve on the mandrel. Once the sleeve is located on the mandrel, the compressed air is released and the compressible layer (2) expands and attaches the sleeve to the mandrel as in FIG. 19B. The sleeve can be removed by applying compressed air to the mandrel.

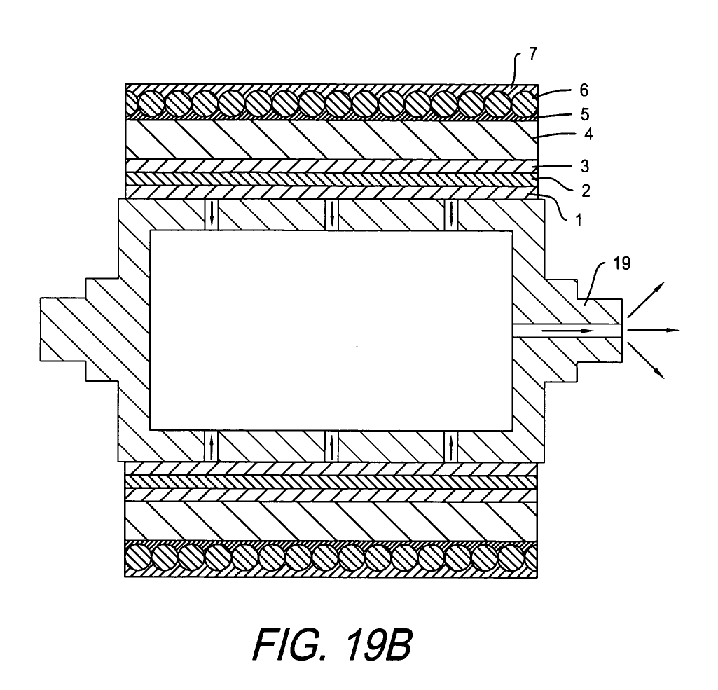

FIG. 20 depicts a longitudinal cross-section view of a composite cylindrical core, referred to as a sleeve, produced from a fiber composite layer (1), a compressible layer (2), a fiber composite layer (3) a polymer layer (4) with attached metal end caps (21) layer of adhesive (5), wire (6) and a coating (7). The figure illustrates an end cap (21) with a slightly larger inside diameter than the inside diameter of the composite cylindrical core to allow for compression of the compressible layer (2) for mounting on an air assisted mandrel.

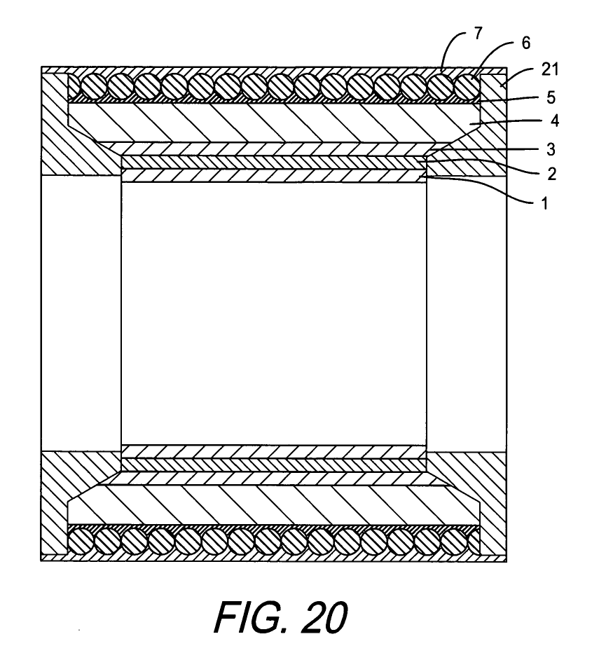

FIG. 21 depicts a longitudinal cross-section view of a composite cylindrical core, referred to as a sleeve, produced from a fiber composite layer (1), a compressible layer (2), a fiber composite layer (3), a polymer layer (4), a layer of adhesive (5), wire (6) and a coating (7) with locking metal end caps (20) attached with a locking groove and adhesive (22). The figure illustrates an end cap (20) with a slightly larger inside diameter than the inside diameter of the composite cylindrical core to allow for compression of the compressible layer (2) for mounting on an air assisted mandrel.

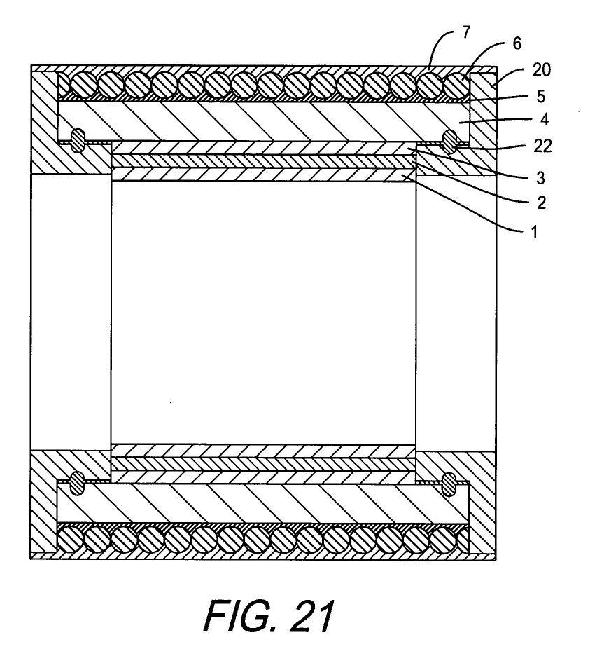

### DETAILED DESCRIPTION OF THE INVENTION

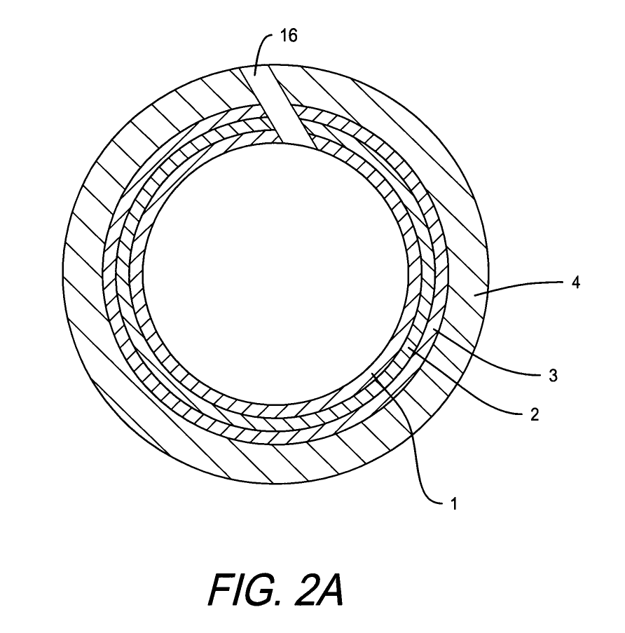

Referring to FIG. 2A, there is shown a composite cylindrical core, commonly referred to as a sleeve, consisting of two concentric, cylindrical fiber-glass layers (1 and 3, respectively) separated by a compressible foam material (2) and an outer, concentric, cylindrical urethane layer (4). This is a composite core available from Rotec Corp. of Fletcher, N.C. and others.

In FIG. 2A, an attachment hole (16) is drilled at a 60° angle to tangent and 0.025 inch from the end of the sleeve, on both ends of the sleeve. The sleeve is slid onto an air assisted mandrel which is then mounted in the wrapping machine. The outer surface of the roll is sprayed with an adhesive (5), not more than 0.004 inch thick, while slowly rotating at about 10 rpm. Insert end of round 0.030 inch diameter Stainless Steel wire into attachment hole on one end of sleeve as in FIG. 2B. Wrap sleeve with one layer of wire (6) winding at 100 rpm with traverse/index equal to the diameter of the wire and minimum 12 lbs tension. Trim wire, and anchor remaining end of wire to cylindrical core as in FIG. 2B. This procedure may be performed with a conventional wire winding machine, filament winder, or a lathe with a wire feed assembly. If a filament winder is used, the adhesive applicator head can be utilized to apply the adhesive.

After wrapping, grit blast with 60 mesh aluminum oxide at 40 psi while rotating at 150 rpm and traversing at 60 inches per minute. Following this procedure, blow off dust with compressed air.

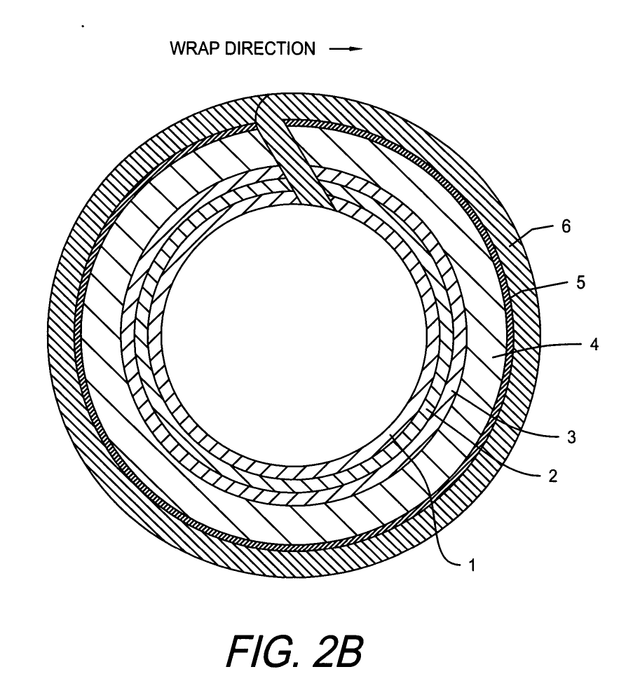

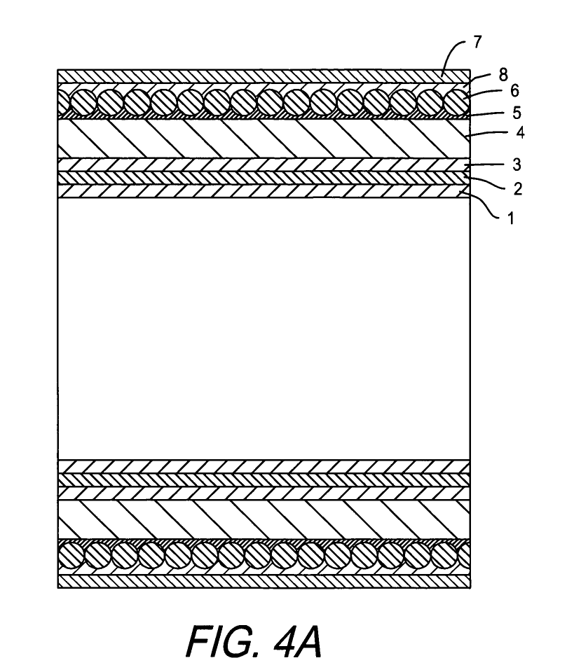

Apply 0.008 to 0.010 inch of chrome oxide coating (7) above the peak radius of the wire layer (6) with a Plasma Gun (17) as in FIG. 6 while maintaining temperature less than 200° F. with carbon dioxide as a cooling gas (18), and rotating the sleeve at 1200 rpm. FIGS. 3A and 3B shows cross section views of the coated sleeve.

While the sleeve is still warm, epoxy sealer is applied to the coating. After the sealer has cured, the sleeve is ground and finished per customer surface finish requirements. The chrome oxide coating is further laser-engraved to the desired fluid-metering and pattern requirement.

This variation and others will be appreciated by those skilled in the art, and within the intended scope of this invention as claimed below. As previously stated, a detailed embodiment of the present invention is disclosed herein; however, it is to be understood that the disclosed embodiment is merely exemplary of the invention that may be embodied in various forms. Therefore, within the scope of the appended claims, the present invention may be practiced other than as specifically described.

1. A method of making a metal surface about a cylindrical core, the method comprising:
(a) wrapping the cylindrical core with a metal wire; and
(b) applying a layer of coating, consisting of ceramic or carbide or metal or a combination thereof over the wire layer.

2. The method of claim 1 wherein the cylindrical core is comprised of polyester fiber composite, carbon fiber composite, glass fiber composite, kevlar fiber composite, other composite, foam, rubber, polymer, plastic, or any combination thereof.

3. The method of claim 1 wherein the wire is selected from the group comprising aluminum, nickel, steel, stainless steel, copper, zinc or other metals or alloys thereof.

4. The method of claim 1 wherein the wire cross section profile is round, square, rectangular, or otherwise polygonal profile, whereby polygonal profile is a closed plane figure bounded with straight or curved or a combination of curved and straight sides.

5. The method of claim 1 wherein, the wire is flattened or knurled or both.

6. The method of claim 1 wherein the wire is hollow.

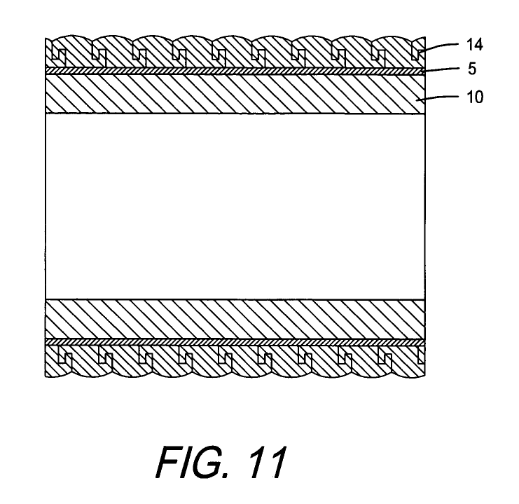

7. The method of claim 1 wherein the wire is a cable comprised of two or more strands as in FIG. 13.

8. The method of claim 1 wherein the cylindrical core is wrapped with one or more layers of wire.

9. The method of claim 1 wherein wrapping the cylindrical core, each turn of the wire lies in continuous contact with the previous turn or each turn of wire is wrapped with a predetermined space between each wire.

10. The method of claim 1 wherein the ceramic layer is selected from the group comprising, but not limited to, chromium oxide, aluminum oxide, titanium oxide, zirconium oxide, and silicon oxide; and the carbide layer is selected from the group comprising, but not limited to, chrome carbide and tungsten carbide; and the metal layer is selected from the group comprised of pseudoalloys, copper, aluminum, nickel, chrome, steel, stainless steel, molybdenum, compounds thereof and alloys thereof.

11. The method of claim 1 wherein one or more layers of coating are applied over the wire layer.

12. The method of claim 1 wherein the layer of coating is applied using a thermal spray process.

13. The method of claim 12, wherein the thermal spray process is selected from the group comprising, but is not limited to, arc wire spray, flame spray, HVOF, plasma spray, detonation gun, cold spray, and gas dynamic spray.

14. The method of claim 1 wherein the layer of coating is applied by the method selected from the group comprising, electroplating, vapor deposition and welding techniques.

15. The method of claim 1 further including before step (a) the cylindrical core is coated with a layer of adhesive.

16. The method of claim 1 further including before step (b) the wire layer is grinded or machined or mechanically roughened or combination thereof.

17. The method of claim 1 further including after step (a) a sealer is applied to the wire wrapped cylindrical core, and said sealer is selected from the group comprising, but not limited to, epoxy-based, polyurethane-based sealers.

18. The method of claim 1 wherein a sealer is applied to the layer of coating, and said sealer is selected from the group comprising, but not limited to, epoxy-based, polyurethane-based sealers.

19. A composite or polymer industrial roll or a composite or polymer industrial sleeve having a metal surface manufactured by wrapping the roll or sleeve surface with a metal wire.

20. The method of claim 19 wherein the wire is selected from the group comprising aluminum, nickel, steel, stainless steel, copper, zinc or other metals or alloys thereof.

21. The method of claim 19 wherein the wire cross section profile is round, square, rectangular, or otherwise polygonal profile, whereby polygonal profile is a closed plane figure bounded with straight or curved or a combination of curved and straight sides.

22. The method of claim 19 wherein, the wire is flattened or knurled or both.

23. The method of claim 19 wherein the wire is hollow.

24. The method of claim 19 wherein the wire is a cable comprised of two or more strands as in FIG. 13.

25. The method of claim 19 wherein the roll or sleeve is wrapped with one or more layers of wire.

26. The method of claim 19 wherein wrapping the roll or sleeve, each turn of the wire lies in continuous contact with the previous turn or each turn of wire is wrapped with a predetermined space between each wire.

27. The method of claim 19 further including before wrapping the roll or sleeve, a layer of adhesive is applied to the roll or sleeve surface.

28. A fluid metering article, comprising:
(a) a cylindrical core wrapped with metal wire;
(b) a layer of thermal sprayed ceramic applied over the wire layer;
(c) the ceramic layer grinded and polished to the predetermined finish; and
(d) the ceramic layer laser-engraved.

29. The method of claim 28 wherein the cylindrical core is comprised of polyester fiber composite, carbon fiber composite, glass fiber composite, kevlar fiber composite, other composite, foam, rubber, polymer, plastic, or any combination thereof.

30. The method of claim 28 wherein the wire is selected from the group comprising aluminum, nickel, steel, stainless steel, copper, zinc or other metals or alloys thereof.

31. The method of claim 28 wherein the wire cross section profile is round, square, rectangular, or otherwise polygonal profile, whereby polygonal profile is a closed plane figure bounded with straight or curved or a combination of curved and straight sides.

32. The method of claim 28 wherein, the wire is flattened or knurled or both.

33. The method of claim 28 wherein wrapping the roll or sleeve, each turn of the wire lies in continuous contact with the previous turn or each turn of wire is wrapped with a predetermined space between each wire.

34. The method of claim 28 further including before wrapping the roll or sleeve, a layer of adhesive is applied to the roll or sleeve surface.

35. The method of claim 28 further including a sealer is applied to the wire wrapped roll or sleeve, and said sealer is selected from the group comprising, but not limited to, epoxy-based, polyurethane-based sealers.

36. The method of claim 28 further including after step (a) the wire layer is grinded or machined or mechanically roughened or combination thereof.

37. The method of claim 28 further including before step (b) a layer of metal is applied to the wire layer.

38. The method of claim 37 wherein the metal layer is grinded or machined or mechanically roughened or sealed or a combination thereof.

39. The method of claim 28 wherein, after step (b) a sealer is applied to the ceramic layer, and said sealer is selected from the group comprising, but not limited to, epoxy-based, polyurethane-based sealers.
